(19) United States
(12) Patent Application Publication
(10) Pub. No.: US 2026/0032717 A1
(43) Pub. Date: Jan. 29, 2026

(54) ACCESS POINT AND TERMINAL

(71) Applicant: NIPPON TELEGRAPH AND TELEPHONE CORPORATION, Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/997,933

(22) PCT Filed: Aug. 10, 2022
(86) PCT No.: PCT/JP2022/030554

§ 371 Date: Jan. 23, 2025

(51) Int. Cl. H04W 74/04; H04W 84/12

(52) U.S. Cl. CPC H04W 74/04; H04W 84/12

(57) ABSTRACT

An access point includes an address management part, a transmission prohibition management part, and a transmission part. The address management part broadcasts a group address of a group set for terminals which are able to perform preferential exchange of data frames during a service period to terminals that are members of the group among the terminals under control thereof. The transmission prohibition management part generates a transmission prohibition frame including a first field storing a time length of the service period and a second field storing the group address. The transmission part transmits a transmission prohibition signal including the transmission prohibition frame to the terminals.

### TECHNICAL FIELD

Embodiments relate to an access point and a terminal.

### BACKGROUND ART

A wireless local area network (LAN) is known as a system for wirelessly connecting an access point (AP) and a terminal. A wireless LAN allows terminals located within the communication range of an AP to access the network via the AP. APs and terminals may provide service periods for preferentially exchanging low-latency traffic in some cases. A function which provides such a service period is called a restricted TW (r-TWT) function.

### CITATION LIST

### Non Patent Literature

NPL 1: IEEE P802. 11be™/D1.5, “35.9 Restricted TWT (r-TWT)”, Mar. 18, 2022

### SUMMARY OF INVENTION

### Technical Problem

Some terminals do not support an r-TWT function. In order to enable preferential exchange of low-latency traffic even when there are terminals which do not support the r-TWT function, setting a transmission suppression period using a quiet interval for the terminals which do not support the r-TWT function) is also being considered. However, the time length of the quiet interval set together with the service period is determined to be a predetermined time shorter than the service period. Although a plurality of transmission suppression periods may be set during a service period, the transmission suppression period set by the quiet period does not cover the entire service period. For this reason, at the end of a certain transmission suppression period or the like, there is a possibility that an interruption in transmission by another terminal which does not exchange low-latency traffic may occur.

An embodiment has been made with attention to the above circumstances and an object of the embodiment. is to provide a wireless communication environment in which low-latency traffic can be exchanged preferentially even when there are terminals that do not support the r-TWT function.

### Solution to Problem

An access point in an embodiment includes an address management part, a transmission prohibition management part, and a transmission part. The address management part broadcasts a group address of a group set for terminals which are able to perform preferential exchange of data frames during a service period to terminals that are members of the group among the terminals under control thereof. The transmission prohibition management part generates a transmission prohibition frame including a first field storing a time length of the service period and a second field storing the group address. The transmission part transmits a transmission prohibition signal including the transmission prohibition frame to the terminals.

### Advantageous Effects of Invention

According to an embodiment, it is possible to provide a wireless communication environment in which low-latency traffic can be exchanged preferentially even when there is a terminal which does not support the r-TWT function.

### BRIEF DESCRIPTION OF DRAWINGS

FIG. 1 is a block diagram showing an example of

a configuration of a communication system according to an embodiment.

FIG. 2 is a block diagram showing an example of a hardware configuration of an AP according to the embodiment.

FIG. 3 is a block diagram showing an example of a hardware configuration of a terminal according to the embodiment.

FIG. 4 is a block diagram showing an example of a functional configuration of the AP according to the embodiment.

FIG. 5A is a diagram showing a first example of a format of a beacon frame according to the embodiment.

FIG. 5B is a diagram showing a second example of the format of the beacon frame according to the embodiment.

FIG. 6 is a diagram showing a format of a transmission prohibition frame according to the embodiment.

FIG. 7 is a block diagram showing an example of a functional configuration of the terminal according to the embodiment.

FIG. 8 is a block diagram showing an example of a functional configuration relating to transmission determination processing of the terminal according to the embodiment.

FIG. 9 is a flowchart for describing an example of an r-TWT setup operation using the AP according to the embodiment.

FIG. 10 is a flowchart for describing an operation of the terminal.

FIG. 11 is a diagram showing an example of an operation during a service period r-TWT-SP using a system according to the embodiment.

### DESCRIPTION OF EMBODIMENTS

Embodiments will be explained below with reference to the drawings. Note that, in the following description, constituent elements having the same function and configuration are denoted by the same reference numerals.

### EMBODIMENTS

### 1. Configuration

A configuration of a communication system according to an embodiment will be explained.

### 1.1 Communication System

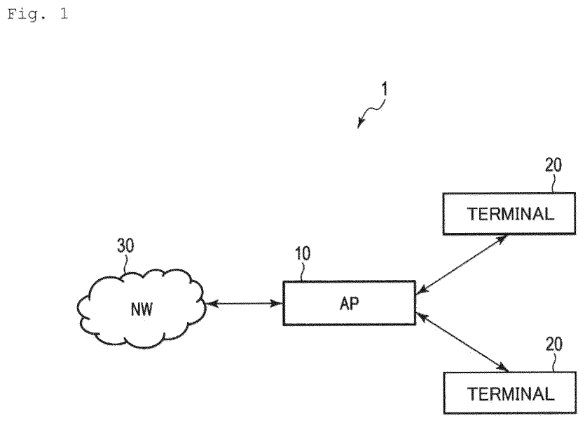

FIG. 1 is a block diagram showing an example of a configuration of a communication system according to an embodiment.

As shown in FIG. 1, a communication system 1 includes an access point (AP) 10, terminals 20, and a network 30.

The AP 10 is, for example, a wireless LAN base station. The AP 10 is configured to communicate with a server (not shown) on the network 30 in a wired or wireless manner. The AP 10 is configured to communicate with the terminals 20 in a wireless manner. Communication between the AP 10 and the terminals 20 complies with, for example, the IEEE 802. 11 standard.

The terminals 20 are, for example, wireless terminals such as a smartphone or a personal computer (PC). The terminals 20 are configured to communicate with a server on the network 30 via the AP 10. In FIG. 1, two of the terminals 20 are shown. The number of terminals 20 included in the communication system 1 may be one or three or more.

The AP 10 and the terminal 20 have, for example, a wireless communication function based on an open systems interconnection (OSI) reference model. In the OSI reference model, the wireless communication function has 7 layers (first layer: physical layer, second layer: data link layer, third layer: network layer, fourth layer: transport layer, fifth layer: session layer, sixth layer: presentation layer, seventh layer: application layer). The data link layer includes a logical link control (LLC) sub-layer and a media access control (MAC) sub-layer.

The AP 10 has an r-TWT function to ensure an opportunity to exchange traffic that requires low latency. By using the r-TWT function, the AP 10 can set a service period in which the exchange of traffic which requires low latency can be prioritized over the exchange of traffic which does not require low latency. Such a service period is also called r-TWT-SP (Service Period). On the other hand, the terminal 20 may or may not support the r-TWT function. For example, when two or more of the terminals 20 exist, only some of the terminals 20 may support the r-TWT function. Here, the terminals 20 which do not support the r-TWT function are terminals which do not support the r-TWT function because they are old standard terminals which cannot understand messages relating to r-TWT include terminals which do not support the r-TWT function, which are standard terminals which can understand messages relating to r-TWT.

### 1.2 Hardware Configurations

Hardware configurations of the AP and the terminals in the communication system according to the embodiment will be explained below.

### 1.2.1 AP Hardware Configuration

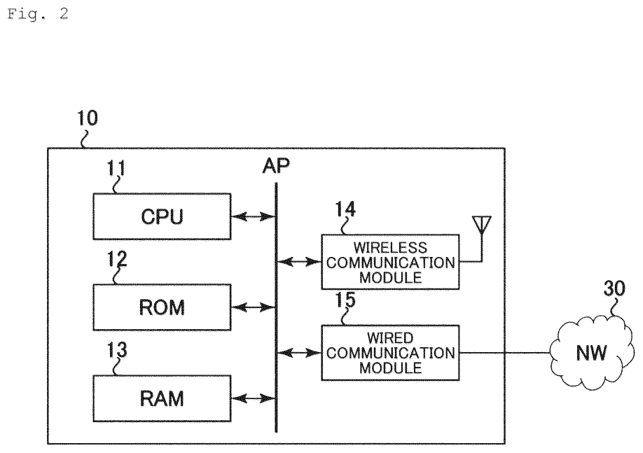

FIG. 2 is a block diagram showing an example of a hardware configuration of the AP according to the embodiment. As shown in FIG. 2, the AP 10 includes, for example, a central processing unit (CPU) 11, a read only memory (ROM) 12, a random access memory (RAM) 13, a wireless communication module 14, and a wired communication module 15.

The CPU 11 is a processing circuit which controls the overall operation of the AP 10. The ROM 12 is, for example, a non-volatile semiconductor memory. The ROM 12 stores programs and data for controlling the AP10. The RAM 13 is, for example, a volatile semiconductor memory. The RAM 13 is used as a work area for the CPU 11. The wireless communication module 14 is a circuit used for transmitting and receiving data using wireless signals. The wireless communication module 14 is connected to the antenna. The wired communication module 15 is a circuit used for transmitting and receiving data using wired signals. The wired communication module 15 is connected to the network 30.

### 1.2.2 Terminal Hardware Configuration

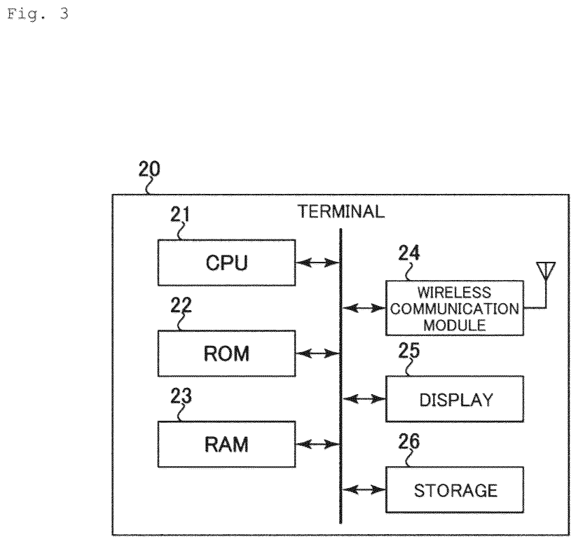

FIG. 3 is a block diagram showing an example of a hardware configuration of the terminal according to the embodiment. As shown in FIG. 3, the terminal 20 includes, for example, a CPU 21, & ROM 22, a RAM 23, a wireless communication module 24, a display 25, and a storage 26.

The CPU 21 is a processing circuit which controls the overall operation of the terminal 20. The ROM 22 is, for example, a non-volatile semiconductor memory. The ROM 22 Stores programs and data for controlling the terminal 20. The RAM 23 is, for example, a volatile semiconductor memory. The RAM 23 is used as a work area for the CPU 21. The wireless communication module 24 is a circuit used for transmitting and receiving data using wireless signals. The wireless communication module 24 is connected to the antenna. The display 25 is, for example, a liquid crystal display (LCD) or an electro-Luminescence (EL) display. The display 25 displays a graphical user interface (GUI) or the like corresponding to application software. The storage 26 is a non-volatile storage device. The storage 26 stores system software of the terminal 20 and the like.

### 1.3 Functional Configuration

Functional configurations of the AP and the terminal in the communication system according to the embodiment will be explained below.

### 1.3.1 AP Functional Configuration

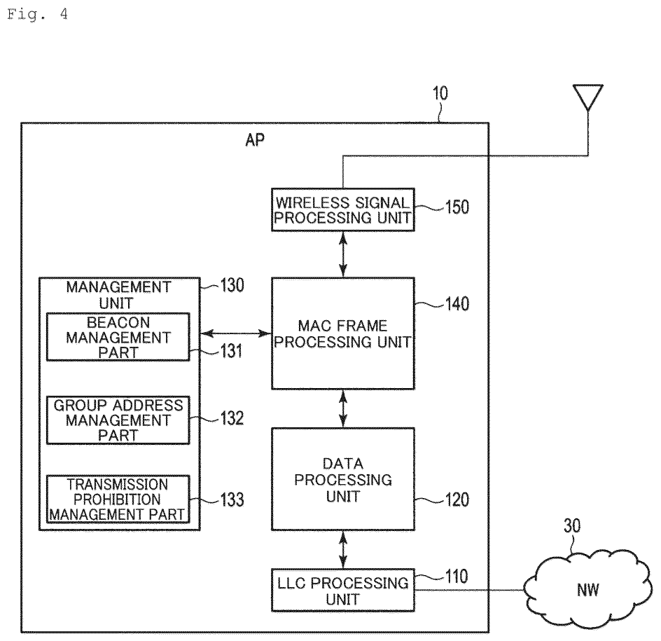

FIG. 4 is a block diagram showing an example of a functional configuration of the AP according to the embodiment. The AP 10 functions as a computer including an LLC processing unit 110, a data processing unit 120, a management unit 130, a MAC frame processing unit 140, and a wireless signal processing unit 150. The LLC processing unit 110 is a functional block which performs processing corresponding to the LLC sub-layer of the second layer and the third to seventh layers. The data processing unit 120, the management unit 130, and the MAC frame processing unit 140 are functional blocks which perform processing corresponding to the MAC sub-layer of the second layer. The wireless signal processing unit 150 is a functional block which performs processing corresponding to the MAC sub-layer of the second layer and the first layer.

The LLC processing unit 110 generates an LLC packet by adding, for example, a destination service access point (DSAP) header, a source service access point (SSAP) header, or the like to the data received from the network 30, Also, the LLC processing unit 110 inputs the generated LLC packet to the data processing unit 120. In addition, the LLC processing unit 110 extracts data from the LLC packet input from the data processing unit 120, Furthermore, the LLC processing unit 110 transmits the extracted data to the network 30.

The data processing unit 120 adds a MAC header to the LLC packet input from the LLC processing unit 110 to generate a MAC frame. Also, the data processing unit 120 inputs the generated MAC frame to the MAC frame processing unit 140. Furthermore, the data processing unit 120 extracts LLC packets from the MAC frame input from the MAC frame processing unit 140. In addition, the data processing unit 120 inputs the extracted LLC packet to the LLC processing unit 110. In the following, MAC frames including data are also referred to as “data frames.”

The management unit 130 manages communication between the AP 10 and the terminal 20. For example, the management unit 130 sets up r-TWT when low latency traffic is scheduled to be exchanged. In the r-TWT setup, the management unit 130 sets a service period r-TWT-SP for the terminal 20 which supports the r-TWT function. Furthermore, the management unit 130 is configured so that, during the service period r-TWT-SP, traffic exchange using the terminal 20 which is scheduled to exchange low latency traffic is performed with priority over traffic exchange using the terminal 20 which is not scheduled to exchange low-latency traffic. Various MAC frames are input and output between the management unit 130 and the MAC frame processing unit 140. The management unit 130 includes a beacon management part 131, a group address management part 132, and a transmission prohibition management part 133.

The beacon management part 131 manages information transmitted by the AP 10 as a beacon signal. Specifically, the beacon management part 131 generates a beacon frame which includes r-TWT management information relating to the r-TWT function. Also, the beacon management part 131 inputs the generated beacon frame to the MAC frame processing unit 140.

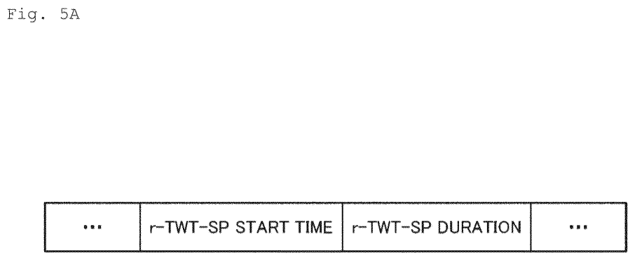

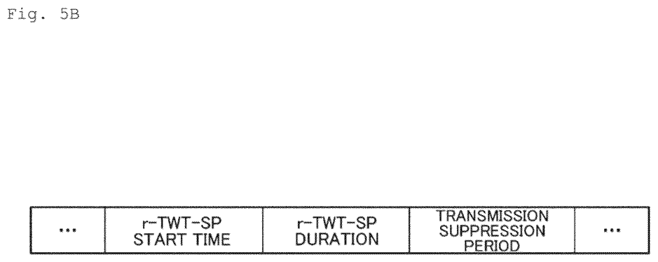

FIG. 5A is a diagram showing a first example of the format of the beacon frame according to the embodiment. As shown in FIG. 5A, the beacon frame of the first example includes, for example, an r-TWT-SP start time and an r-TWT-SP duration as r-TWT management information used in the r-TWT function.

The r-TWT-SP start time is information indicating a time at which the service period r-TWT-SP starts. The r-TWT-SP duration is information indicating a length of the service period r-TWT-SP. That is to say, the service period r-TWT-SP is set as the period from the r-TWT-SP start time to the time at which the r-TWT-SP duration has elapsed.

The terminal 20 supporting the r-TWT function can recognize the service period r-TWT-SP using the r-TWT-SP start time and the r-TWT-SP duration included in the beacon frame. On the other hand, the terminal 20 which does not support the r-TWT function ignores it depending on the r-TWT-SP start time and the r-TWT-SP duration included in the beacon frame irrespective of whether the service period r-TWT-SP cannot be recognized or can be recognized.

FIG. 5B is a diagram showing a second example of the format of the beacon frame according to the embodiment. As shown in FIG. 5B, the beacon frame of the second example includes, for example, a transmission suppression period in addition to the r-TWT-SP start time and the r-TWT-SP duration as r-TWT management information used in the r-TWT function.

The transmission suppression period is a period during which transmission of data frames is suppressed. The transmission suppression period can be set using, for example, a quiet interval defined in the IEEE 802.11 standard. A time length of the quiet interval as the transmission suppression period is, for example, 1 time unit (TU). Furthermore, the transmission suppression period is set to overlap with the service period. Specifically, the start time of the transmission suppression period is set to be the same as the r-TWT-SP start time. A plurality of transmission suppression periods may be set during r-TWT-SP. A terminal 20 which does not support the r-TWT function can also recognize the transmission suppression period. On the other hand, even when the terminal 20 which supports the r-TWT function receives the notification of the transmission suppression period, it behaves as when there was no notification.

Here, the transmission suppression period may be transmitted to the terminal 20 using a MAC frame such as a trigger frame which is different from the beacon frame.

The group address management part 132 manages a group address A. A group address A is an address for identifying a group of terminals 20 which can perform traffic exchange with priority during the service period r-TWP-SP. As the group address A, a broadcast address may be used, a multicast group address assigned to a group including the AP 10 which schedules the service period r-TWT-SP and the subordinate terminals 20 thereof may be used, and a unique address determined using the AP 10 which schedules the service period r-TWT-SP may be used. The AP 10 broadcasts the group address A to the terminals 20 included as members before setting up the service period r-TWT-SP. For example, the broadcasting may be provided by transmitting an action frame including the group address A to the terminals 20 included in the members. The broadcasting may be provided using other methods.

Furthermore, the group address management part 132 manages a list of members belonging to the group of group address A. Before scheduling the service period r-TWT-SP, the group address management part 132 lists the terminals 20 which are scheduled to exchange low-latency traffic as members belonging to the group of a group address A. Furthermore, when receiving a request for low-latency traffic exchange from a terminal 20 which is not a member, the group address management part 132 may add the requesting terminal 20 to the list as a member belonging to the group of the group address A. Also, when the exchange of low-latency traffic in the terminal 20 is completed, the group address management part 132 may remove the terminal 20 from the members belonging to the group with the group address A.

The transmission prohibition management part 133 manages information in which the AP 10 transmits as a transmission prohibition signal during the service period r-TWT-SP. Specifically, the transmission prohibition management part 133 generates a transmission prohibition frame which includes information for prohibiting the exchange of low-latency traffic during the service period r-TWT-SP. Also, the transmission prohibition management part 133 inputs the generated transmission prohibition frame to the MAC frame processing unit 140.

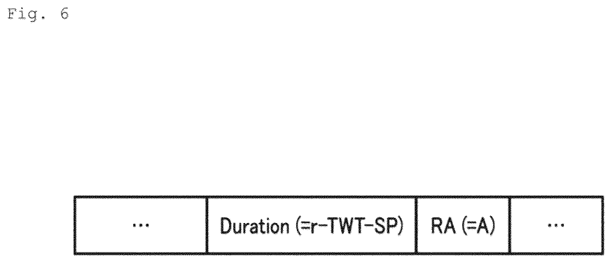

FIG. 6 is a diagram showing a format of a transmission prohibition frame according to the embodiment. The transmission prohibition frame includes a Duration field and an RA field.

The Duration field indicates the scheduled period for using the wireless line. In the case of a transmission prohibition frame, the time length of the service period r-TWT-SP is stored in the Duration field.

An RA (Receiving STA address) field indicates the address of the receiving terminal. In the case of a transmission prohibition frame, a value of group address A is stored in the RA field.

The transmission prohibition frame may be generated, for example, as a multi-user Request to Send (MU-RTS) trigger frame, which is addressed to a group including the terminals 20 under the AP 10. However, the transmission prohibition frame may be a frame other than the MU-RTS trigger frame. For example, the transmission prohibition frame may be a Clear to Send (CTS) frame which is addressed to the AP 10 itself or may be a uniquely defined frame which includes a Duration field and an RA field. Fields other than the Duration field and the RA field may be set as appropriate depending on the type of frame adopted as the transmission prohibition frame.

The information stored in the Duration field and the RA field in a transmission prohibition frame having such a format can be recognized using either the terminal 20 which does not support the r-TWT function or the terminal 20 which supports the r-TWT function.

Here, the trigger frame can include information for allocating communication resources such as frequency, transmission timing, and transmission period to a specific terminal or terminal group. However, the trigger frame used as the transmission prohibition frame in the embodiment does not need to include information for allocating communication resources to such a specific terminal or terminal group.

Referring to FIG. 4 again, the functional configuration of the AP 10 will be explained. When the MAC frame is input from the data processing unit 120 or the management unit 130, the MAC frame processing unit 140 inputs the input MAC frame to the wireless signal processing unit 150. Furthermore, when a MAC frame is input from the wireless signal processing unit 150, the MAC frame processing unit 140 inputs the MAC frame to the data processing unit 120 or the management unit 130 depending on the type of the MAC frame. Specifically, the MAC frame processing unit 140 inputs the MAC frame to the data processing unit 120 when the MAC frame is a data frame. The MAC frame processing unit 140 inputs the MAC frame to the management unit 130 when the MAC frame is a management frame or a control frame.

The wireless signal processing unit 150 adds a preamble and the like to the MAC frame input from the MAC frame processing unit 140 to generate a wireless frame. The wireless signal processing unit 150 converts the generated wireless frame into a wireless signal. Also, the wireless signal processing unit 150 radiates (transmits) the converted wireless signal via the antenna. The conversion process from a wireless frame to a wireless signal includes, for example, convolutional encoding processing, interleaving processing, sub-carrier modulation processing, inverse fast Fourier transform processing, orthogonal frequency division multiplexing (OFDM) modulation processing, and frequency conversion processing. Furthermore, the wireless signal processing unit 150 converts a wireless signal received from the terminal 20 via the antenna into a wireless frame, The conversion process from a wireless signal to a wireless frame includes, for example, frequency conversion processing, OFDM demodulation processing, fast Fourier transform processing, sub-carrier demodulation processing, deinterleaving processing, and Viterbi decoding processing. The wireless signal processing unit 150 extracts the MAC frame from the converted wireless frame. Also, the wireless signal processing unit 150 inputs the extracted MAC frame to the MAC frame processing unit 140.

Furthermore, the wireless signal processing unit 150 performs transmission determination processing to determine whether a data frame can be transmitted at the time of transmitting a wireless frame. The transmission determination processing will be explained later.

### 1.3.2 Terminal Functional Configuration

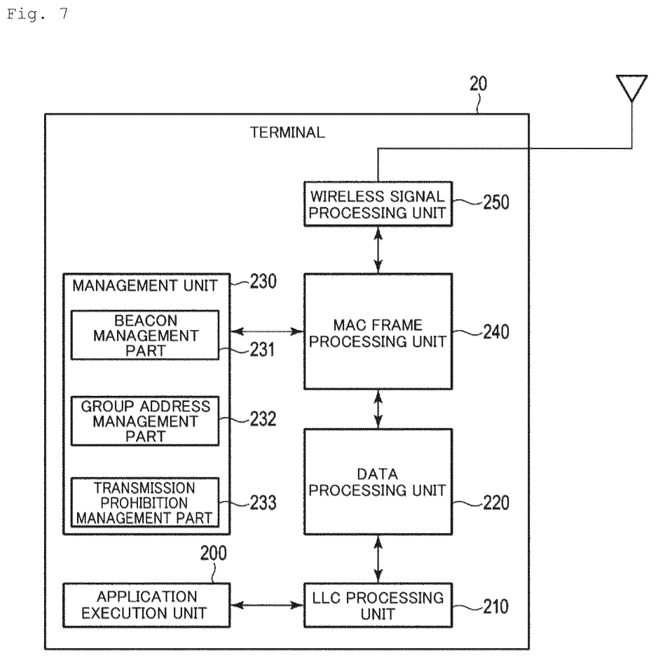

FIG. 7 is a block diagram showing an example of a functional configuration of a terminal according to the embodiment. The terminal 20 functions as a computer including an application execution unit 200, an LLC processing unit 210, a data processing unit 220, a management unit 230, a MAC frame processing unit 240, and a wireless signal processing unit 250. The application execution unit 200 is a functional block which performs processing corresponding to the seventh layer. The LLC processing unit 210 is a functional block which performs processing corresponding to the LLC sub-layer of the second layer and the third to sixth layers. The data processing unit 220, the management unit 230, and the MAC frame processing unit 240 are functional blocks which perform processing corresponding to the MAC sub-layer of the second layer. The wireless signal processing unit 250 is a functional block which performs processing corresponding to the MAC sub-layer of the second layer and the first layer.

The application execution unit 200 performs an application on the basis of data input from the LLC processing unit 210. Furthermore, the application execution unit 200 inputs data to the LLC processing unit 210. For example, the application execution unit 200 can display application information on the display 25. Furthermore, the application execution unit 200 can operate on the basis of the operation of the input interface.

The LLC processing unit 210 adds a DSAP header, an SSAP header, or the like to the data input from the application execution unit 200 and generates an LLC packet. Also, the DLC processing unit 210 inputs the generated LLC packet to the data processing unit 220. In addition, the LLC processing unit 210 extracts data from the LLC packet input from the data processing unit 220. Also, the LLC processing unit 210 inputs the extracted data to the application execution unit 200.

The data processing unit 220 adds a MAC header to the LLC packet input from the LLC processing unit 210 to generate a MAC frame. Furthermore, the data processing unit 220 inputs the generated MAC frame to the MAC frame processing unit 240. Furthermore, the data processing unit 220 extracts LLC packets from the MAC frame input from the MAC frame processing unit 240. In addition, the data processing unit 220 inputs the extracted LLC packet to the LLC processing unit 210.

The management unit 230 manages communication between the AP 10 and the terminals 20. Various MAC frames are input and output between the management unit 230 and the MAC frame processing unit 240. The management unit 230 includes a beacon management part 231, a group address management part 232, and a transmission prohibition management part 233.

The beacon management part 231 manages information included in the beacon signal received from the AP 10. Specifically, the beacon management part 231 extracts management information relating to the r-TWT function from the beacon frame input from the MAC frame processing unit 240 and holds the extracted management information. For example, the beacon management part 231 of the terminal 20 which supports the r-TWT function extracts the r-TWT-SP start time and the r-TWT-SP duration as management information relating to the r-TWT function. Furthermore, for example, the beacon management part 231 of the terminal 20 which supports the r-TWT function and the terminal 20 which does not support the r-TWT function extracts the transmission suppression period as management information relating to the r-TWT function.

The group address management part 232 manages information relating to the group address A broadcast from the AP 10. Specifically, the group address management part 232 extracts a group address A from the MAC frame input from the MAC frame processing unit 240 and holds the extracted group address A.

The transmission prohibition management part 233 determines whether the address stored in the RA field is the group address A held in the group address management part 232 when a transmission prohibition frame is input. When the address stored in the RA field is not the group address A held in the group address management part 232, that is, when the terminal 20 is not a member of the group, the transmission prohibition management part 233 sets a network allocation vector (NAV) of the time length of the service period r-TWT-SP stored in the Duration field. Thus, the terminal 20 which is not a member does not transmit the wireless signal during the service period r-TWT-SP. On the other hand, when the address stored in the RA field is the group address A held in the group address management part 232, that is, when the terminal 20 is a member of the group, the transmission prohibition management part 233 sets the NAV by reading the value stored in the Duration field as 0. That is to say, the terminal 20 which is a member does not set the NAV. Thus, the terminal 20 which is a member can transmit wireless signals with priority during the service period r-TWT-SP.

When the MAC frame is input from the data processing unit 220 or the management unit 230, the MAC frame processing unit 240 inputs the input MAC frame to the wireless signal processing unit 250. Furthermore, when a MAC frame is input from the wireless signal processing unit 250, the MAC frame processing unit 240 inputs the MAC frame to the data processing unit 220 or the management unit 230 depending on the type of the MAC frame. Specifically, the MAC frame processing unit 240 inputs the MAC frame to the data processing unit 220 when the MAC frame is a data frame. The MAC frame processing unit 240 inputs the MAC frame to the management unit 230 when the MAC frame is a management frame or a control frame.

The wireless signal processing unit 250 adds a preamble and the like to the MAC frame input from the MAC frame processing unit 240 to generate a wireless frame. The wireless signal processing unit 250 converts the generated wireless frame into a wireless signal. Also, the wireless signal processing unit 250 radiates (transmits) the converted wireless signal via the antenna. The conversion process from a wireless frame to a wireless signal includes, for example, convolutional encoding processing, interleaving processing, sub-carrier modulation processing, inverse fast Fourier transform processing, OFDM modulation processing, and frequency conversion processing. Furthermore, the wireless signal processing unit 250 converts the wireless signal received from the AP 10 via the antenna into a wireless frame. The conversion process from a wireless signal to a wireless frame includes, for example, frequency conversion processing, OFDM demodulation processing, fast Fourier transform processing, sub-carrier demodulation processing, deinterleaving processing, and Viterbi decoding processing. The wireless signal processing unit 250 extracts the MAC frame from the converted wireless frame. Also, the wireless signal processing unit 250 inputs the extracted MAC frame to the MAC frame processing unit 240.

Furthermore, the wireless signal processing unit 250 performs transmission determination processing to determine whether a data frame can be transmitted at the time of transmitting a wireless frame. The transmission determination processing will be explained later.

### 1.3.3 Functional Configuration Relating to Transmission Determination Processing

Functional configurations relating to transmission determination processing of each of the AP 10 and the terminals 20 according to the embodiment will be explained below.

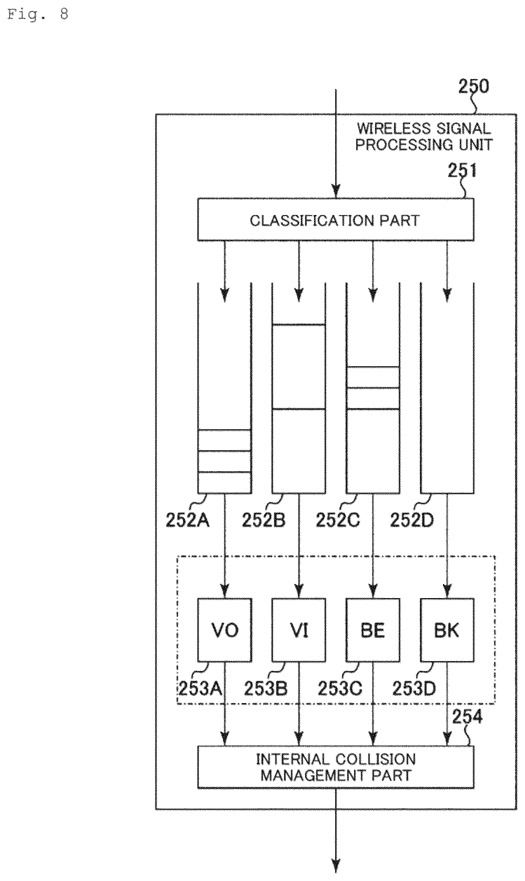

FIG. 8 is a block diagram showing an example of a functional configuration relating to transmission determination processing of the terminal according to the embodiment. FIG. 8 shows the functional configuration of the wireless signal processing unit 250 as a functional configuration relating to transmission determination processing of the terminal. On the other hand, the functional configuration relating to the transmission determination processing of the AP is also equivalent to the functional configuration shown in FIG. 8.

The wireless signal processing unit 250 includes a classification part 251, a plurality of queues 252A, 252B, 252C, and 252D, a plurality of carrier sensing parts 253A, 253B, 253C, and 253D, and an internal collision management part 254.

When the MAC frame input from the MAC frame processing unit 240 is a data frame, the classification part 251 classifies the data frame into a plurality of access categories on the basis of a traffic indicator (TID) included in the MAC header. The TID is an identifier indicating traffic and can be associated with an access category, Traffic access categories include, for example, “voice (VO),” “video (VI),” “best effort (BE),” and “background (BK).” The classification part 251 inputs the data frame into a corresponding one of the plurality of queues 252A, 252B, 252C, and 252D. In the example of FIG. 8, the classification part 251 inputs data frames corresponding to access categories VO, VI, BE, and BK to queues 252A, 2528, 252C, and 252D, respectively.

Each of the plurality of queues 252A, 252B, 252C, and 252D buffers input data frames. In the example of FIG. 8, the plurality of queues 252A, 2528, 252C, and 252D buffer data frames corresponding to access categories VO, VI, BE, and BK, respectively.

The plurality of carrier sensing parts 253A, 253B, 253C, and 253D correspond to the plurality of queues 252A, 2528, 252C, and 252D, respectively. Each of the plurality of carrier sensing parts 253A, 253B, 253C, and 253D performs carrier sensing processing based on carrier sense multiple access with collision avoidance (CSMA/CA) according to preset access parameters. When it is determined that the channel is in an idle state for a predetermined period of time, each of the plurality of carrier sensing parts 253A, 253B, 253C, and 253D acquires the right to transmit a data frame and ends the carrier sensing processing. When it is determined that the channel is in a busy state, each of the plurality of carrier sensing parts 253A, 253B, 253C, and 253D stops acquiring the transmission right and ends the carrier sensing processing.

As access parameters used in carrier sensing processing, for example, CWmin, CWmax, an arbitration inter frame space (AIFS), and a transmission opportunity (TXOP)Limit are used. CWmin and CWmax indicate the minimum and maximum contention window values, respectively. The contention window is a parameter which indicates the time range within which random backoff for collision avoidance is determined. The AIFS is a fixed transmission waiting time set for each access category. The TXOPLimit indicates an upper limit of the channel occupation period TXOP. That is to say, the shorter CWmin, CWmax, and AIFS are set the access category, the easier it is to acquire the transmission right. Furthermore, the larger the TXOPLimit is set for the access category, the larger the amount of data which can be transmitted with one transmission right.

The internal collision management part 254 prevents transmission collision when two or more carrier sensing parts acquire transmission rights at the same time. Specifically, for example, when a plurality of data frames are input at the same time, the internal collision management part 254 preferentially transmits a data frame of an access category with a high priority.

### 2. Operation

An operation of the r-TWT function in the communication system according to the embodiment will be explained below.

2.1 r-TWT Setup Operation

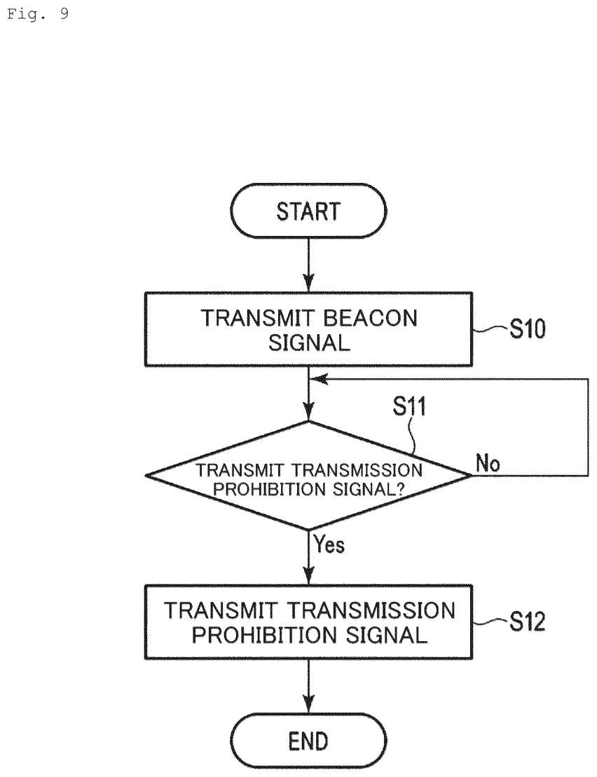

FIG. 9 is a flowchart for describing an example of an r-TWT setup operation using the AP according to the embodiment. Here, before the r-TWT setup operation shown in FIG. 9, the group address management part 132 of the management unit 130 has already broadcast the group address A to the terminals 20 that are members.

In Step $10, the beacon management part 131 performs processing for transmitting a beacon signal for r-TWT setup. Specifically, the beacon management part 131 generates a beacon frame including the r-TWT-SP start time and the r-TWT-SP duration and inputs the generated beacon frame to MAC frame processing unit 140. The MAC frame processing unit 140 inputs the beacon frame to the wireless signal processing unit 150. The wireless signal processing unit 150 generates a beacon signal from the beacon frame and radiates (transmits) the beacon signal from the antenna. Here, as shown in FIG. 5B, the beacon frame may further include a transmission suppression period. Moreover, the beacon signal is periodically transmitted at a predetermined cycle. When transmitting a beacon signal during a period when there is no need to set up r-TWT, the beacon frame does not need to include the r-TWT-SP start time and r-TWT-SP duration, Furthermore, when the service period r-TWT-SP needs to be set at a constant cycle, the transmission cycle of the beacon signal may be determined in accordance with the service period r-TWT-SP.

In Step S11, the transmission prohibition management part 133 determines whether to transmit a transmission prohibition signal. It is determined that the transmission prohibition signal is to be transmitted when the timing to transmit the transmission prohibition signal has come. The timing to transmit the transmission prohibition signal is the timing at which the r-TWT-SP start time has arrived or the timing at which the exchange of transmission prohibition frames is scheduled to end at the r-TWT-SP start time. When the time scheduled for the end of the exchange of the transmission prohibition frame at the r-TWT-SP start time is adopted as the timing for transmitting the transmission prohibition signal, the exchange of transmission prohibition frames is determined to have ended, for example, when acknowledgments are received from all the terminals 20 targeted for exchange of transmission prohibition frames. The transmission prohibition management part 133 may predict the delay required for exchanging the transmission prohibition frame with the target terminal 20 on the basis of the carrier sense result of the wireless signal processing unit 150 in advance and the delay information collected from the terminal 20 and decide the transmission time of the transmission prohibition signal in accordance with the predicted delay, Furthermore, the exchange of transmission prohibition frames may be performed using a frame exchange procedure different from enhanced distributed channel access (EDCA), which is a frame exchange procedure which takes into account the above-described access category. For example, a frame exchange procedure may be adopted which waits for the distributed inter frame space (DIFS) time without carrier sensing, and then transmits a transmission prohibition signal without waiting for the random backoff time. In this case, the transmission prohibition management part 133 may decide the transmission time of the transmission prohibition signal in accordance with the DIFS standby time. In Step S11, the process waits until it is determined that a transmission prohibition signal is to be transmitted. While processing is waiting, the AP 10 may perform an exchange of data frames with the terminal 20. When it is determined in Step S11 that a transmission prohibition signal is to be transmitted, the process proceeds to Step S12.

In Step S12, the transmission prohibition management part 133 generates a transmission prohibition frame in which the value of the service period r-TWT-SP is stored in the Duration field and the value of the group address A is stored in the RA field, and inputs the generated transmission prohibition frame to the MAC frame processing unit 140. The MAC frame processing unit 140 inputs the transmission prohibition frame to the wireless signal processing unit 150. The wireless signal processing unit 150 generates a transmission prohibition signal from the transmission prohibition frame and radiates (transmits) the transmission prohibition signal from the antenna. After that, the process in FIG. 9 ends. As described above, the transmission prohibition frames may be various MAC frames such as MU-RTS trigger frames and CTS to Self frames, in which the service period r-TWT-SP value is stored in the Duration field and the address A value is stored in the RA field. Furthermore, it is preferable that transmission prohibition frames be exchanged within a short period of time. Therefore, the transmission prohibition transmission frame may be transmitted using the highest priority access category of EDCA. Alternatively, the transmission prohibition frame may be transmitted using a frame exchange procedure in which exchange is completed earlier than a frame exchange procedure using EDCA.

### 2.2 Terminal Operation

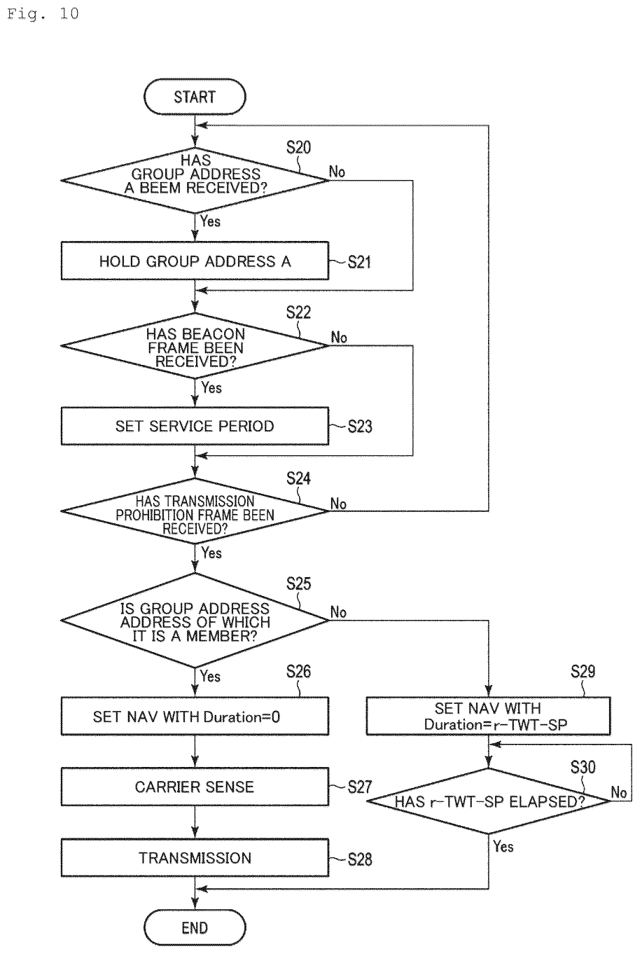

FIG. 10 is a flowchart for describing an operation of the terminal. Here, FIG. 10 shows an operation of the terminal 20 from the r-TWT setup operation to the service period r-TWT-SP. Furthermore, for the sake of explanation, it is assumed that the exchange of transmission prohibition frames is completed at the r-TWT-SP start time.

In Step S20, the group address management part 232 of the management unit 230 determines whether it has received the broadcasting of the group address A from the AP 10. In Step S20, when it is determined that it has received the broadcasting of the group address A, the process proceeds to Step S21. In Step S20, when it is determined that it has not received the broadcasting of the group address A, the process proceeds to Step S22.

In Step S21, the group address management part 232 holds the group address A.

In Step S22, the beacon management part 231 determines whether a beacon frame has been received from the AP 10 via the MAC frame processing unit 240. When it is determined in Step S22 that a beacon frame has been received, the process proceeds to Step S23. When it is determined in Step S22 that the beacon frame has not been received, the process proceeds to Step S24.

In Step S23, the beacon management part 231 extracts management information relating to the r-TWT function from the beacon frame and sets the service period by retaining the extracted management information. Here, the beacon management part 231 of the terminal supporting the r-TWT function holds the service period r-TWT-SP on the basis of the r-TWT-SP start time and r-TWT-SP duration stored in the beacon frame. On the other hand, the beacon management part 231 of a terminal which does not support the r-TWT function discards the r-TWT-SP start time and the r-TWT-SP duration stored in the beacon frame. The beacon management part 231 of a terminal which does not support the r-TWT function also holds the transmission suppression period when the transmission suppression period is stored in the beacon frame.

In Step S24, the transmission prohibition management part 233 determines whether a transmission prohibition frame has been received. When it is determined in Step S24 that a transmission prohibition frame has been received, the process proceeds to Step S25. When it is determined in Step S24 that the transmission prohibition frame has not been received, the process returns to Step S20.

In Step S25, the transmission prohibition management part 233 determines whether the group address stored in the RA field of the transmission prohibition frame is an address of which it is a member. For example, when the group address stored in the RA field of the transmission prohibition frame matches the group address A stored in the group address management part 232, it is determined that the group address stored in the RA field of the transmission prohibition frame is an address of which it itself is a member. On the other hand, when the group addresses A do not match or when the group address A is not stored, it is determined that the group address stored in the RA field of the transmission prohibition frame is not an address of which it itself is a member. When it is determined in Step S25 that the group address stored in the RA field of the transmission prohibition frame is an address of which it itself is & member, the process proceeds to Step S26. When it is determined in Step S25 that the group address stored in the RA field of the transmission prohibition frame is not an address of which it itself is a member, the process proceeds to Step S23.

In Step S26, the transmission prohibition management part 233 regards the value of the Duration field as 0 and sets an NAV with a time length of 0. This is the same as not setting a NAV. Assuming that the exchange of transmission prohibition frames is completed at the r-TWT-SP start time, the member terminal 20 can acquire the right to transmit data frames at the start of the service period.

In Step S27, the MAC frame processing unit 240 inputs a data frame to be exchanged with the AP 10, for example, a low-latency traffic data frame, to the wireless signal processing unit 250. The wireless signal processing unit 250 performs carrier sense on the basis of the access category of the data frame. When the data frame can be transmitted due to carrier sense, the process proceeds to Step S28.

In Step S28, the wireless signal processing unit 250 radiates (transmits) a wireless signal including the data frame to be exchanged with the AP 10 from the antenna. After that, the process in FIG. 10 ends.

In Step S29, the transmission prohibition management part 233 sets the NAV of the time length of the value r-TWT-SP of the Duration field. Assuming that the exchange of transmission' prohibition frames is completed at the r-TWT-SP start time, the terminal 20 that is not a member does not acquire the right to transmit the data frame through the setting of the NAV from the start of the service period r-TWT-SP.

In Step S30, the transmission prohibition management part 233 determines whether the r-TWT-SP time has elapsed. In Step S30, when the r-TWT-SP time has not elapsed, the process is put on standby. In Step S30, when the r-TWT-SP time has not elapsed, the process in FIG. 10 ends. After that, the terminal 20 that is not a member can also acquire the right to transmit data frames.

2.3 Operation Example During Service Period r-TWT-SP

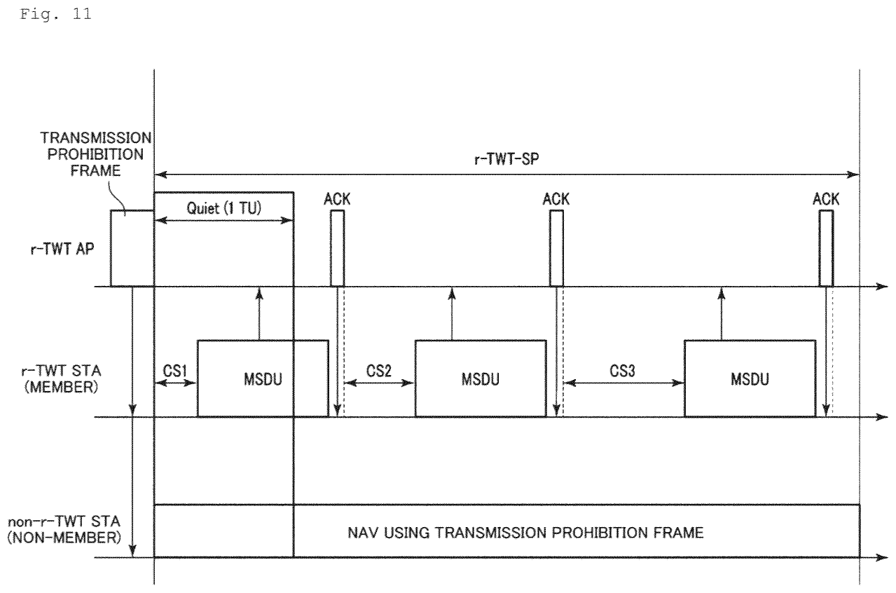

FIG. 11 is a diagram showing an example of an operation during the service period r-TWT-SP using the system according to the embodiment. In FIG. 11, an example of two terminals under the AP is shown. One of the terminals is a member terminal r-TWT STA which supports an r-TWT function, The other terminal is a non-r-TWT STA that is a non-member terminal which does not support the r-TWT function. Furthermore, in FIG. 11, a transmission suppression period Quiet is set. A time length of the transmission suppression period Quiet is 1 TU.

As shown in FIG. 11, first, a transmission prohibition frame is transmitted from the AP to the subordinate terminals r-TWT STA and non-r-TWT STA at the r-TWT-SP start time.

The terminal r-TWT STA identifies that it is a member terminal using the address value stored in the RA field of the transmission prohibition frame. Also, the terminal r-TWT STA sets the NAV with the Duration field value set to 0. In this case, NAV ends with the start of r-TWT-SP. Therefore, the terminal r-TWT STA can immediately acquire the right to transmit data frames with the AP. As a transmission right acquisition operation, the terminal r-TWT STA performs carrier sense CS. The waiting time due to carrier sense CS includes fixed waiting times such as AIFS and DIFS and random backoff time. Also, during carrier sense CS, when no other terminal transmits a wireless signal, the terminal E-TWT STA transmits a wireless signal including a data frame MAC Service Data Unit (MSDU). The wireless signal is received at the AP, and an acknowledgment (ACK) is returned from the AP. When there are remaining data frames to be transmitted or when a retransmission request is made from the AP, the terminal r-TWT STA repeatedly performs the same data frame exchange operation.

On the other hand, the terminal non-r-TWT STA identifies that it is not a member terminal using the address value stored in the RA field of the transmission prohibition frame. In this case, the terminal non-r-TWT STA sets the NAV according to the value of the Duration field in the same way as when receiving a conventional RTS frame or CTS to Self frame. Here, the value of the Duration field is set to the time length of the service period r-TWT-SP. Therefore, the terminal non-r-TWT STA does not acquire the right to transmit data frames during the service period r-TWT-SP. Thus, the transmission of wireless signals using the member terminal r-TWT STA is not interrupted through the transmission of wireless signals using the terminal non-r-TWT STA.

Here, although not shown in FIG. 11, a terminal that is not a member supporting the r-TWT function can also operate in the same manner as the terminal non-r-TWT STA. Therefore, the transmission of wireless signals using the member terminal r-TWT STA is not interrupted using the transmission of wireless signals using a terminal that is not a member supporting the r-TWT function.

### 3. Effects Relating to Embodiments

A terminal which does not support the r-TWT function cannot recognize the r-TWT-SP start time and r-TWT-SP duration as r-TWT management information or even when it recognizes it, ignores it. Therefore, a terminal which does not support the r-TWT function will attempt to exchange data frames even when the service period is set using the AP. Thus, this will affect the exchange of low-latency traffic during the service period.

According to the embodiment, the time length of the service period r-TWT-SP is stored as the value of the Duration field and a transmission prohibition frame in which the group address of a group of terminals which can preferentially exchange low-latency traffic during the service period r-TWT-SP is stored as the value of the RA field is transmitted from the AP to the subordinate terminals. At this time, the terminal which does not support the r-TWT function sets the same NAV as when receiving the conventional RTS frame or CTS-to-Self frame during the service period r-TWT-SP. Thus, low-latency traffic exchange during the service period is performed preferentially.

In this way, according to the embodiment, even when there is a terminal which does not support the r-TWT function, it is possible to provide a wireless communication environment in which low latency traffic can be exchanged preferentially.

### 4. Modification Examples And Like

Note that the above-described embodiment can be modified in various ways. For example, in the embodiment described above, communication between the AP and the terminal is said to be so-called single link communication, in which communication is performed using one channel. On the other hand, in recent years, multilink communication which perform communication using two or more channels has been studied. Embodiments may also be applied in the case of multi-link communication, In the case of multi-link communication, the service period r-TWT-SP is set for each link. Therefore, the value of the Duration field of the transmission prohibition frame stores the time length of the service period r-TWT-SP set for the corresponding link. Furthermore, the value of the RA field of the transmission prohibition frame stores the value of the group address of the terminal which exchanges low-latency traffic on the corresponding link. Also, the transmission prohibition frame is transmitted for each link. The operation of the AP and the terminal for each link is the same as in the embodiment described above.

Furthermore, the transmission determination processing according to the embodiment and modification examples described above can be stored as a program which can be executed using a processor that is a computer, In addition, the program can be stored and distributed in a storage medium of an external storage device such as a magnetic disk, an optical disc, or a semiconductor memory. Also, the processor reads the program stored in the storage medium of the external storage device and an operation thereof is controlled using the read program, whereby the transmission determination processing is able to be performed.

Note that the present invention is not limited to the above-described embodiments and can be variously modified at the implementation stage without departing from the gist thereof. Moreover, each embodiment may be implemented in combination as appropriate, and in that case, the combined effect can be obtained. Furthermore, the embodiments described above include various inventions and various inventions can be extracted by combinations selected from the plurality of constituent features disclosed. For example, if a problem can be solved and an effect can be obtained even when some constituent features are deleted from all the constituent features shown in the embodiment, the configuration from which these constituent features are deleted can be extracted as an invention.

### REFERENCE SIGNS LIST

1 Communication system
10 Access point (AP)
20 Terminal
30 Network
11, 21 CPU
12, 22 ROM
13, 23 RAM
14, 24 Wireless communication module
15 Wired communication module
25 Display
26 Storage
200 Application execution unit
110, 210 LLC processing unit
120, 220 Data processing unit
130, 230 Management unit
131, 231 Beacon management part
132, 232 Group address management part
133, 233 Transmission prohibition management part
140, 240 MAC frame processing unit
150, 250 Wireless signal processing unit
251 Classification part
252A, 252B, 252C, 252D Queue
253A, 253B, 2530, 253D Carrier sensing part
254 Internal collision management part

1. An access point, comprising a processor with hardware configured to:
broadcast a group address of a group set for terminals which are able to perform preferential exchange of data frames during a service period to terminals that are members of the group among the terminals under control thereof;
generate a transmission prohibition frame including a first field storing a time length of the service period and a second field storing the group address; and
a transmit a transmission prohibition signal including the transmission prohibition frame to the terminals.

2. The access point according to claim 1, wherein the first field is a duration field, and
the second field is a receiving station address (RA) field.

3. The access point according to claim 1, wherein the processor transmits the transmission prohibition frame at a start time of the service period or transmits the transmission prohibition frame so that exchange of the transmission prohibition frame with the terminals ends at the start time of the service period.

4. The access point according to claim 1, wherein the data frame is a data frame which requires low latency.

5. The access point according to claim 1, wherein the transmission prohibition frame is a trigger frame.

6. A terminal, comprising a processor with hardware configured to:
receive, from an access point, a transmission prohibition signal which includes a transmission prohibition frame including a first field storing a time length of a service period and a second field storing a group address of a group set for terminals which are able to perform preferential exchange of data frames during the service period;
manage an address broadcast in advance from the access point; and
perform control so that, when the group address is not an address broadcast in advance from the access point, a network allocation vector (NAV) of the time length of the service period stored in the first field is set, and when the group address is an address broadcast in advance from the access point, the NAV is not set.
